(19) United States
(12) Patent Application Publication
(10) Pub. No.: US 2019/0233327 A1
(43) Pub. Date: Aug. 1, 2019

(54) Anti-Corrosion Coating for a Glass Substrate

(71) Applicant: Guardian Glass, LLC, Auburn Hills, MI (US)

(72) Inventor: Liang Liang, Taylor, MI (US)

(21) Appl. No.: 16/235,175

(22) Filed: Dec. 28, 2018

Related U.S. Application Data
(60) Provisional application No. 62/611,026, filed on Dec. 28, 2017.

(51) Int. Cl. C03C 17/32; C09D 133/26; C09D 179/04; C09D 101/02; C09D 5/08

(52) U.S. Cl. CPC C03C 17/32; C09D 133/26; C09D 179/04; C03C 2218/112; C09D 5/08; C03C 2217/78; C09D 101/02

(57) ABSTRACT

A coated glass substrate is disclosed as well as a method of making the coated glass substrate. In one embodiment, the coated glass substrate includes a glass substrate and a coating on a surface of the glass substrate wherein the coating includes a polycationic polymer and wherein the coated glass substrate has (1) a Delta of greater than 165, (2) an average corrosion percent of less than 7%, or (3) both. The coating provides a glass substrate with improved anti-corrosion properties.

### CROSS-REFERENCE TO RELATED APPLICATION

The present application claims filing benefit of U.S. Provisional Patent Application Ser. No. 62/611,026 having a filing date of Dec. 28, 2017, and which is incorporated herein by reference in its entirety.

### BACKGROUND

After glass substrates are manufactured, they are typically stored for a certain period of time. During such storage, the surfaces of the glass substrates are prone to damage by moisture which negatively affects the quality of the glass substrate. For instance, water molecules may attack the Si—O bonds in the glass substrate thereby releasing sodium ions. These sodium ions can then react with the water to form sodium hydroxide which results in the corrosion of the glass substrate. This corrosion may result in a glass substrate having an undesirable, rough surface. Various types of coatings have been employed to minimize corrosion of the glass substrates during such periods of storage. However, corrosion in undesired amounts has still been observed when employing such coatings.

As a result, there is a need to provide a coating on a glass substrate with improved anti-corrosion properties.

### SUMMARY

In general, one embodiment of the present disclosure is directed to a coated glass substrate comprising a glass substrate and a coating on a surface of the glass substrate wherein the coating includes a polycationic polymer and wherein the coated glass substrate has (1) a Delta of greater than 165, (2) an average corrosion percent of less than 7%, or (3) both.

### DETAILED DESCRIPTION

### Definitions

It is to be understood that the terminology used herein is for the purpose of describing particular embodiments only and is not intended to limit the scope of the present invention.

“Alkyl” refers to a monovalent saturated aliphatic hydrocarbyl group, such as those having from 1 to 25 carbon atoms and, in some embodiments, from 1 to 12 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), neopentyl ((CH₃)₃CCH₂), hexyl (CH₃(CH₂CH₂CH₂)₅), etc.

“Substituted alkyl” refers to an alkyl group having from 1 to 5 and, in some embodiments, 1 to 3 or 1 to 2 substituents selected from alkenyl, substituted alkenyl, alkynyl, substituted alkynyl, alkoxy, substituted alkoxy, acyl, acylamino, acyloxy, amino, substituted amino, quaternary amino, aminocarbonyl, imino, amidino, aminocarbonylamino, am idinocarbonylamino, aminothiocarbonyl, aminocarbonylamino, aminothiocarbonylamino, aminocarbonyloxy, aminosulfonyl, aminosulfonyloxy, aminosulfonylamino, aryl, substituted aryl, aryloxy, substituted aryloxy, arylthio, substituted arylthio, azido, carboxyl, carboxyl ester, (carboxyl ester)amino, (carboxyl ester)oxy, cyano, cycloalkyl, substituted cycloalkyl, cycloalkyloxy, substituted cycloalkyloxy, cycloalkylthio, substituted cycloalkylthio, guanidino, substituted guanidino, halo, hydroxy, hydroxyamino, alkoxyamino, hydrazino, substituted hydrazino, heteroaryl, substituted heteroaryl, heteroaryloxy, substituted heteroaryloxy, heteroarylthio, substituted heteroarylthio, heterocyclic, substituted heterocyclic, heterocyclyloxy, substituted heterocyclyloxy, heterocyclylthio, substituted heterocyclylthio, nitro, oxo, thione, spirocycloalkyl, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, and substituted alkylthio, wherein said substituents are as defined herein.

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C=C<). For example, (Cₓ-C_{y})alkenyl refers to alkenyl groups having from x to y carbon atoms and is meant to include for example, ethenyl, propenyl, 1,3-butadienyl, and so forth.

“Alkynyl” refers to a linear monovalent hydrocarbon radical or a branched monovalent hydrocarbon radical containing at least one triple bond. The term “alkynyl” is also meant to include those hydrocarbyl groups having one triple bond and one double bond. For example, (C₂-C₆)alkynyl is meant to include ethynyl, propynyl, and so forth.

“Alkoxy” refers to a straight or branched alkoxy group containing the specified number of carbon atoms. For example, C₁₋₆alkoxy means a straight or branched alkoxy group containing at least 1, and at most 6, carbon atoms. Examples of “alkoxy” as used herein include, but are not limited to, methoxy, ethoxy, prop-1-oxy, prop-2-oxy, but-1-oxy, but-2-oxy, 2-methylprop-1-oxy, 2-methylprop-2-oxy, pentoxy and hexyloxy.

“Aryl” refers to a carbocyclic aromatic moiety (such as phenyl or naphthyl) containing the specified number of carbon atoms, particularly from 6-10 carbon atoms. Examples of aryl radicals include, but are not limited to, phenyl, naphthyl, indenyl, azulenyl, fluorenyl, anthracenyl, phenanthrenyl, tetrahydronaphthyl, indanyl, phenanthridinyl and the like. Unless otherwise indicated, the term “aryl” also includes each possible positional isomer of an aromatic hydrocarbon radical, such as in 1-naphthyl, 2-naphthyl, 5-tetrahydronaphthyl, 6-tetrahydronaphthyl, 1-phenanthridinyl, 2-phenanthridinyl, 3-phenanthridinyl, 4-phenanthridinyl, 7-phenanthridinyl, 8-phenanthridinyl, 9-phenanthridinyl and 10-phenanthridinyl. Examples of aryl radicals include, but are not limited to, phenyl, naphthyl, indenyl, azulenyl, fluorenyl, anthracenyl, phenanthrenyl, tetrahydronaphthyl, indanyl, phenanthridinyl and the like.

It should be understood that the aforementioned definitions encompass unsubstituted groups, as well as groups substituted with one or more other groups as is known in the art. For example, an alkyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, epoxy, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

### Detailed Description

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In general, the present disclosure is directed to a coated glass substrate containing a coating that includes a polycationic polymer. The present inventor has discovered that employing certain polymers, such as certain water-soluble polymers, can provide an anti-corrosive effect to a glass substrate. Typically, corrosion of the glass substrate is due to a reaction between water and the sodium ions present in the glass substrate wherein such reaction yields the formation of sodium hydroxide. The present inventor has discovered that using the coating as employed herein can minimize the formation of such sodium hydroxide and in turn inhibit or reduce the corrosion of the glass substrate. For instance, with the presence of a polycationic polymer, the counterion can be employed to react with the sodium thereby minimizing the formation of sodium hydroxide. In other words, the polycationic polymer can be employed to essentially “starve” the water, in particular the hydroxyl groups, of the sodium ions thereby minimizing, or even preventing, the formation of sodium hydroxide.

Furthermore, the present inventor has discovered that the inclusion of other polymers may provide a coating with improved durability. For instance, these polymers may form physical crosslinks or interact with the polycationic polymer. In particular, a physical crosslink or interaction can be created between the cation of the polycationic polymer and a functional group of another polymer. Such functional group may be any functional group capable of forming a crosslink or interacting. For instance, the functional group may be a carboxyl group, an amine group, a carbonyl group, in particular the oxygen atom of the carbonyl group. However, in addition to durability, the presence of these polymers may also assist with the anti-corrosion effect of the coating as defined herein.

In particular, the corrosion can be characterized by the reflection of light on the surface of the glass substrate using ellipsometry. In general, Delta is the phase difference induced by reflection wherein Delta is equal to (Delta_{before}-Delta_{after}) wherein Delta_{before} is the phase difference before the reflection and Delta_{after} is the phase difference after the reflection. The value of Delta may range from −180° to +180°. Also, generally higher Delta values correspond to lower corrosion of the glass substrate or in other words, improved anti-corrosion performance of the coating. Such Delta values may also be indicative of the surface roughness of the glass substrate. After conditioning the coated glass substrate as defined herein in a chamber at 85° C. and 85% humidity for 24 hours, Delta may be 165 or greater, such as 166 or greater, such as 167 or greater, such as 168 or greater, such as 169 or greater, such as 170 or greater, such as 170.5 or greater, such as 171 or greater, such as 172 or greater, such as 172.5 or greater, such as 173 or greater, such as 173.5 or greater, such as 174 or greater. After conditioning the coated glass substrate as defined herein in a chamber at 85° C. and 85% humidity for 24 hours, Delta may be 180 or less, such as 178 or less, such as 176 or less, such as 175 or less.

The aforementioned Delta values may then be utilized to determine an average corrosion % of the sample. For instance, corrosion % is obtained by the equation (Delta_{RG}-Delta_{CG})/Delta_{RG}*100 wherein Delta_{RG} is the Delta value of the raw, uncoated glass before conditioning in a chamber at 85° C. and 85% humidity for 24 hours and Delta_{CG} is the Delta value of the coated glass substrate after conditioning in a chamber at 85° C. and 85% humidity for 24 hours. The coated glass substrate as defined herein may have an average corrosion % of less than 7%, such as less than 6%, such as less than 5%, such as less than 4.5%, such as less than 4%, such as 3.9% or less, such as such as 3.7% or less, such as 3.5% or less, such as 3.3% or less, such as 3.1% or less, such as 3% or less, such as 2.9% or less, such as 2.5% or less, such as 2.3% or less, such as 2% or less. The coated glass substrate as defined herein may have an average corrosion % of greater than 0%, such as 0.1% or more, such as 0.2% or more, such as 0.3% or more, such as 0.5% or more, such as 1% or more, such as 1.5% or more, such as 2% or more, such as 2.5% or more.

In addition, because of the minimized corrosion, the surface roughness of the coated glass substrate after conditioning in a chamber at 85° C. and 85% humidity for 24 hours can be similar to the surface roughness of the raw, uncoated glass substrate that was not conditioned in a chamber at 85° C. and 85% humidity for 24 hours. For instance, the glass substrate (with the coating and after conditioning in a chamber at 85° C. and 85% humidity for 24 hours) may have an average surface roughness (Ra) of 0.5 nm or less, such as 0.4 nm or less, such as 0.3 nm or less, such as 0.25 nm or less, such as 0.2 nm or less to more than 0 nm, such as 0.05 nm or more, such as 0.1 nm or more, such as 0.15 nm or more. The glass substrate (with the coating and after conditioning in a chamber at 85° C. and 85% humidity for 24 hours) may have a root mean squared surface roughness (Rq) of 0.5 nm or less, such as 0.4 nm or less, such as 0.3 nm or less, such as 0.25 nm or less to more than 0 nm, such as 0.05 nm or more, such as 0.1 nm or more, such as 0.15 nm or more, such as 0.2 nm or more. Such Ra and/or Rq may be within 70%, such as within 60%, such as within 50%, such as within 40% of the Ra and/or Rq of the raw, uncoated glass substrate that was not conditioned in a chamber at 85° C. and 85% humidity for 24 hours. The surface roughness may be measured using a profilometer, such as an atomic force microscope (AFM).

Furthermore, because the attack of the Si—O bonds can be reduced with a reduction in the formation of sodium hydroxide, the hydrogen concentration at various depths can be reduced for a coated glass substrate conditioned in a chamber at 85° C. and 85% humidity for 24 hours in comparison to a raw, uncoated glass substrate conditioned without a coating. For instance, after conditioning in a chamber at 85° C. and 85% humidity for 24 hours, the coated glass substrate of the present disclosure may have a hydrogen concentration of 8E+21 or less, such as 7E+21 or less, such as 6E+21 or less at a depth of 0 nm, such as on the surface of the glass substrate. The coated glass substrate may have a hydrogen concentration of 3.0E+21 or less, such as 2.5E+21 or less, such as 2E+21 or less at a depth of 5 nm. The coated glass substrate may have a hydrogen concentration of 2.5E+21 or less, such as 2E+21 or less, such as 1.9E+21 or less, such as 1.7E+21 or less at a depth of 10 nm. The coated glass substrate may have a hydrogen concentration of 2E+21 or less, such as 1.8E+21 or less, such as 1.7E+21 or less, such as 1.6E+21 or less at a depth of 20 nm. In addition, at a depth of 5 nm, the coated glass substrate, after conditioning in a chamber at 85° C. and 85% humidity for 24 hours, has a hydrogen concentration that is within 30%, such as within 20%, such as within 15%, such as within 10%, such as within 5% of the hydrogen concentration of a raw, uncoated glass substrate that was not conditioned in a chamber at 85° C. and 85% humidity for 24 hours. At a depth of 10 nm, the coated glass substrate, after conditioning in a chamber at 85° C. and 85% humidity for 24 hours, has a hydrogen concentration that is within 50%, such as within 40%, such as within 35%, such as within 30% of the hydrogen concentration of a raw, uncoated glass substrate that was not conditioned in a chamber at 85° C. and 85% humidity for 24 hours. The hydrogen concentration can be determined using secondary ion mass spectrometry (SIMS).

A. Glass Substrate

The glass substrate typically has a thickness of from about 0.1 to about 15 millimeters, in some embodiments from about 0.5 to about 10 millimeters, and in some embodiments, from about 1 to about 8 millimeters. The glass substrate may be formed by any suitable process, such as by a float process, fusion, down-draw, roll-out, etc. Regardless, the substrate is formed from a glass composition having a glass transition temperature that is typically from about 500° C. to about 700° C. The composition, for instance, may contain silica (SiO₂), one or more alkaline earth metal oxides (e.g., magnesium oxide (MgO), calcium oxide (CaO), barium oxide (BaO), and strontium oxide (SrO)), and one or more alkali metal oxides (e.g., sodium oxide (Na₂O), lithium oxide (Li₂O), and potassium oxide (K₂O)).

SiO₂ typically constitutes from about 55 mol. % to about 85 mol. %, in some embodiments from about 60 mol. % to about 80 mol. %, and in some embodiments, from about 65 mol. % to about 75 mol. % of the composition. Alkaline earth metal oxides may likewise constitute from about 5 mol. % to about 25 mol. %, in some embodiments from about 10 mol. % to about 20 mol. %, and in some embodiments, from about 12 mol. % to about 18 mol. % of the composition. In particular embodiments, MgO may constitute from about 0.5 mol. % to about 10 mol. %, in some embodiments from about 1 mol. % to about 8 mol. %, and in some embodiments, from about 3 mol. % to about 6 mol. % of the composition, while CaO may constitute from about 1 mol. % to about 18 mol. %, in some embodiments from about 2 mol. % to about 15 mol. %, and in some embodiments, from about 6 mol. % to about 14 mol. % of the composition. Alkali metal oxides may constitute from about 5 mol. % to about 25 mol. %, in some embodiments from about 10 mol. % to about 20 mol. %, and in some embodiments, from about 12 mol. % to about 18 mol. % of the composition. In particular embodiments, Na₂O may constitute from about 1 mol. % to about 20 mol. %, in some embodiments from about 5 mol. % to about 18 mol. %, and in some embodiments, from about 8 mol. % to about 15 mol. % of the composition. Of course, other components may also be incorporated into the glass composition as is known to those skilled in the art. For instance, in certain embodiments, the composition may contain aluminum oxide (Al₂O₃). Typically, Al₂O₃is employed in an amount such that the sum of the weight percentage of SiO₂ and Al₂O₃does not exceed 85 mol. %. For example, Al₂O₃may be employed in an amount from about 0.01 mol. % to about 3 mol. %, in some embodiments from about 0.02 mol. % to about 2.5 mol. %, and in some embodiments, from about 0.05 mol. % to about 2 mol. % of the composition. In other embodiments, the composition may also contain iron oxide (Fe₂O₃), such as in an amount from about 0.001 mol. % to about 8 mol. %, in some embodiments from about 0.005 mol. % to about 7 mol. %, and in some embodiments, from about 0.01 mol. % to about 6 mol. % of the composition. Still other suitable components that may be included in the composition may include, for instance, titanium dioxide (TiO₂), chromium (III) oxide (Cr₂O₃), zirconium dioxide (ZrO₂), ytrria (Y₂O₃), cesium dioxide (CeO₂), manganese dioxide (MnO₂), cobalt (II, Ill) oxide (Co₃O₄), metals (e.g., Ni, Cr, V, Se, Au, Ag, Cd, etc.), and so forth.

B. Coating

As indicated, a coating is provided on one or more surfaces of the substrate. For example, the glass substrate may contain first and second opposing surfaces, and the coating may thus be provided on the first surface of the substrate, the second surface of the substrate, or both. In one embodiment, for instance, the coating is provided on only the first surface. In such embodiments, the opposing second surface may be free of a coating or it may contain a different type of coating. Of course, in other embodiments, the coating of the present invention may be present on both the first and second surfaces of the glass substrate. In such embodiments, the nature of the coating on each surface may be the same or different.

Additionally, the coating may be employed such that it substantially covers (e.g., 95% or more, such as 99% or more) the surface area of a surface of the glass substrate. However, it should be understood that the coating may also be applied to cover less than 95% of the surface area of a surface of the glass substrate. For instance, the coating may be applied on the glass substrate in a decorative manner.

i. Polycationic Polymer

As indicated herein, the coating includes at least one polycationic polymer. Generally, polycationic polymers include those polymers having a cation, in particular within at least one monomer employed during polymerization. In this regard, such cation may be present as a repeating unit within the polycationic polymer. In addition, such cationic groups may be present within the polymeric backbone or may be present within a side chain or substituent group. Such cationic groups within a side chain may be introduced after polymerization such that the polymer is modified to include such a cationic group. In one particular embodiment, the cationic group is present within the polymeric backbone. In another particular embodiment, the cationic group is present within a side chain of the polymer.

The polycationic polymer may be a homopolymer or a copolymer. For instance, the polycationic polymer may be a homopolymer formed from a single monomer containing a cation (e.g., a monomer containing a quaternary nitrogen atom) or wherein the monomer or polymer is later functionalized or modified to include a cationic group. Alternatively, the polycationic polymer may be a copolymer wherein at least one monomer contains a cation (e.g., a monomer containing a quaternary nitrogen atom) or wherein the monomer or polymer is later functionalized or modified to include a cationic group. In such copolymer, the second monomer may also contain a cation (e.g., a monomer containing a quaternary nitrogen atom) or be modified as a monomer or in the polymer to include a cationic group; however, the second monomer may also be one that does not contain a cationic group, such as one including quaternary nitrogen atom (e.g., acrylamide, acrylate, etc.). In addition, for such polymerization, the monomer (e.g., quaternary ammonium compound) may include one having at one, such as at least two, unsaturated bonds. That is, such monomer may include at least one, such as at least two, carbon-carbon double bonds allowing for the formation of a polymer via a polymerization reaction.

In general, the polycationic polymer may be one generally known in the art and thus may not necessarily be limited by the present invention. The polycationic polymer may be one wherein the cation includes a nitrogen atom or a phosphorus atom. In one embodiment, the cation may include a phosphorus atom. In one particular embodiment, the cation may include a nitrogen atom.

The polycationic polymer can be formed from a compound having the following general structure:

[X+R⁶R⁷R⁸R⁹] [Y⁻]

wherein

X is N or P;

R⁶, R⁷, R⁸, and R⁹ independently of one another can be H, a C₁-C₆ alkyl, a C₁-C₆ alkenyl, a C₁-C₆ alkynyl wherein at least one of R⁶, R⁷, R⁸, and R⁹ includes at least one unsaturated carbon bond; and

Y includes a counterion.

As indicated above, X is N or P. In one embodiment, X is P. In one particular embodiment, X is N. In this regard, the polycationic polymer includes a polymer having a nitrogen atom, a phosphorus atom, or a combination thereof. For instance, the cationic group may include a nitrogen atom, a phosphorus atom, or a combination thereof. In one particular embodiment, the polycationic polymer includes a cation having a nitrogen atom.

When the cation includes a nitrogen atom, such nitrogen atom may be a quaternary nitrogen atom (i.e., ammonium). Such quaternary nitrogen atom may be present within the polymeric backbone or may be present within a side chain or substituent group. In one embodiment, the quaternary nitrogen atoms are present within the polymeric backbone. In addition, such quaternary nitrogen atom may form part of a cyclic ring or aromatic ring.

When the cation includes a phosphorus atom, such phosphorus atom may be a quaternary phosphorus atom (i.e., phosphonium). Such quaternary phosphorus atom may be present within the polymeric backbone or may be present within a side chain or substituent group. In one embodiment, the quaternary phosphorus atoms are present within the polymeric backbone. In addition, such quaternary phosphorus atom may form part of a cyclic ring or aromatic ring.

As indicated above, R⁶, R⁷, R⁸, and R⁹ independently of one another can be H, a C₁-C₆ alkyl, a C₁-C₆ alkenyl, a C₁-C₆ alkynyl wherein at least one of R⁶, R⁷, R⁸, and R⁹ includes at least one unsaturated carbon bond. It should be understood that any two of the aforementioned groups may be combined to form the aforementioned alkyl, alkenyl, or alkynyl groups. For instance, R⁶ and R⁷ may be combined and connected to form a C₁-C₆ alkyl or a C₁-C₆ alkenyl. In addition, it should be understood that the aforementioned groups may also be optionally substituted (e.g., hydroxyl, amino, carboxyl, etc.) as generally known in the art.

In one embodiment, at least two of R⁶, R⁷, R⁸, and R⁹ may be a C₁-C₆ alkyl (e.g., methyl, ethyl, etc.). In one embodiment, at least one, such as at least two, of R⁶, R⁷, R⁸, and R⁹ may a C₁-C₆ alkenyl (e.g., ethenyl, propenyl, etc.). In one particular embodiment, at least two of R⁶, R⁷, R⁸, and R⁹ may be a C₁-C₆ alkyl (e.g., methyl, ethyl, etc.) and at least one of R⁶, R⁷, R⁸, and R⁹ may be a C₁-C₆ alkenyl (e.g., ethenyl, propenyl, etc.). In another particular embodiment, at least one, such as at least two, of R⁶, R⁷, R⁸, and R⁹ may a C₁-C₆ alkenyl (e.g., ethenyl, propenyl, etc.). In one particular embodiment, at least two of R⁶, R⁷, R⁸, and R⁹ may be a C₁-C₆ alkyl (e.g., methyl, ethyl, etc.) and at least two of R⁶, R⁷, R⁸, and R⁹ may be a C₁-C₆ alkenyl (e.g., ethenyl, propenyl, etc.).

As indicated above, at least one of R⁶, R⁷, R⁸, and R⁹ includes at least one unsaturated carbon bond. In this regard, for such polymerization, the compound may include at least one, such as at least two, unsaturated bonds. That is, the compound may include at least one, such as at least two, carbon-carbon double bonds allowing for the formation of a polymer via a polymerization reaction.

As indicated above, the compound above includes a counterion (Y). Suitable counterions for the cationic species may include, for example, halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. In one embodiment, the counterion includes a halide. The halide may be a fluoride, a chloride, a bromide, an iodide, or a mixture thereof. In one embodiment, the halide may be a fluoride. In another embodiment, the halide may be a bromide. In a further embodiment, the halide may be a chloride.

Generally, examples of polycationic polymers include, but are not limited to, the following: (a) quaternized salt of polymers of N-alkylsubstituted aminoalkyl esters of acrylic acids including, for example, poly(diethylaminoethylacrylate) acetate, poly(diethylaminoethyl-methyl acrylate) and the like; (b) quaternized salt of reaction products of a polyamine and an acrylate type compound prepared, for example, from methyl acrylate and ethylenediamine; (c) polymers of (methacryloyloxyethyl)trimethyl ammonium; (d) copolymers of acrylamide and quaternary ammonium compounds such as acrylamide and diallylmethyl(β-propionamido)ammonium chloride, acrylamide(p-methacryloyloxyethyl)trimethylammonium methyl sulfate, and the like; (e) quaternized vinyllactam-acrylamide co-polymers; (f) quaternized salt of hydroxy-containing polyesters of unsaturated carboxylic acids such as poly-2-hydroxy-3-(methacryloxy)propyltrimethylammonium chloride; (g) quaternary ammonium salt of polyimide-amines prepared as the reaction product of styrene-maleic anhydride copolymer and 3-dimethylaminopropylamine; (h) quaternized polyamines; (i) quaternized reaction products of amines and polyesters; (j) quaternized salt of condensation polymers of polyethyleneamines with dichloroethane; (k) quaternized condensation products of polyalkylene-polyamines and epoxy halides; (l) quaternized condensation products of alkylene-polyamines and polyfunctional halohydrins; (m) quaternized condensation products of alkylene-polyamines and halohydrins; (n) quaternized condensation polymer of ammonia and halohydrin; (o) quaternized salt of polyvinylbenzyltrialkylamines such as, for example, polyvinylbenzyltrimethylammonium chloride; (p) quaternized salt of polymers of vinyl-heterocyclic monomers having a ring N such as poly(1,2-dimethyl-5-vinylpyridinium methyl sulfate), poly(2-vinyl-2-imidazolinium chloride) and the like; (q) polydialkyldiallylammonium salt including polydiallyldimethylammonium chloride (polyDADMAC); (r) copolymers of vinyl unsaturated acids, esters and amides thereof and diallyldialkylammonium salts including polymethacrylamidopropyltrimethylammonium chloride (polyMAPTAC), poly(acrylic aciddiallyl-dimethylammonium chloride-hydroxypropylacrylate) (polyAADADMAC-HPA); (s) quaternary salt of ammonia-ethylene dichloride condensation polymers.

The polycationic polymer can be formed from at least one monomer selected from the following: diallyldimethylammonium, allylamine, methylacrylamidopropyltrimethylammonium, acrylamide, methacryloyloxyethyltrimethylammonium, 4-vinyl-benzyltrimethylammonium, 4-vinylpyridinium, 2-vinylpyridium, 4-vinyl-1-methylpyridinium, 1-methyl-2-vinylpyridinium, dimethylaminoethylacrylate, dimethylaminoethylacrylate methyl chloride quaternary, N,N-dimethylacrylamide, N,N-diethylacrylamide, 4-acryloylmorpholine, N-vinylcaprolactam, N-methyl-N-vinylacetamide, N-vinylphthalamide, dimethylaminopropylacrylamide, dimethylaminopropylacrylamide methyl chloride quaternary, acryloxyethyldimethylbenzyl ammonium, acryloxyethyltrimethyl ammonium, dimethylaminoethylmethacrylate, methacryloxyethyldimethylammonium, methacryloxyethyltrimethylbenzylammonium, ethyleneimine, trimethyl-2-methacryloylethylammonium, trimethyl-2-methacrylaminopropylammonium, and mixtures thereof. It should be understood however that any quaternized derivatives of the aforementioned, if not specifically mentioned above, are also included. In one particular embodiment, the polycationic polymer is formed from at least diallyldimethylammonium chloride. However, it should be understood that other quaternary ammonium compounds can be used to form the polycationic polymers.

In addition, other types of monomers may also be employed within the polymerization reaction for the formation of a copolymer. Such monomers may include, but are not limited to, acrylic acid, methacrylic acid, hydroxyethylacrylate, methacrylate, methylmethacrylate, hydroxyethylmethacrylate, methyl acrylate, ethyl acrylate, butyl acrylate, 2-ethyl hexyl acrylate, ethene, propene, styrene, vinyl chloride, isobutylene, and mixtures thereof.

Examples of polycationic polymers include, but are not limited to, poly(diallyldimethylammonium chloride), poly[(3-chloro-2-hydroxypropyl)methacryloxyethyldimethyl-ammonium chloride], poly(acrylamide-methacryloxyethyltrimethyl ammonium bromide), poly(butyl acrylate-methacryloxyethyltrimethyl ammonium bromide), poly(l-methyl-4-vinylpyridinium bromide), poly(l-methyl-2-vinylpyridinium bromide), poly(methyacryloxyethyltriethylammonium bromide), poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethylammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-methacryloamidopropyl-pentamethyl-1,3-propylene-2-ol-ammonium dichloride), and mixtures thereof. While only certain polymers are listed, it should be understood that other polycationic polymers including quaternary ammonium polymers may be employed.

As generally known in the art, at least some polycationic polymers including a quaternary nitrogen atom may include polyquaternium polymers. For instance, polyquaternium polymers include, but are not limited to, polyquaternium-1, polyquaternium-2, polyquaternium-3, polyquaternium-4, polyquaternium-5, polyquaternium-6, polyquaternium-7, polyquaternium-15, polyquaternium-17, polyquaternium-18, polyquaternium-22, polyquaternium-32, polyquaternium-37, polyquaternium-39, polyquaternium-42, polyquaternium-43, polyquaternium-47, etc. The chemical names of such polyquaternium polymers are generally well known in the art. In one particular embodiment, the polycationic polymer includes polyquaternium-6 (i.e., poly(diallyldimethylammonium chloride)).

In addition to the above, the polycationic polymer may be a quaternized cellulose. For instance, the cellulose may be a cellulose derivative. In particular, the cellulose, such as the cellulose derivative, may be one wherein the cation is incorporated with a side group, for instance and not within the backbone of the polymer. The cellulose derivative may be a cellulose ether, a cellulose ether, or a mixture thereof. In particular, the derivative may be a cellulose ether. For instance, the cellulose derivatives include ethyl cellulose, methyl cellulose, a propyl cellulose, or a mixture thereof. In particular, the derivatives may include hydroxyl or carboxyl derivatives. For instance, the derivatives may include hydroxymethyl, hydroxyethyl, hydroxypropyl, carboxymethyl, carboxymethyl, carboxypropyl, hydroxypropylmethyl, or a mixture thereof.

The quaternized portion of the cellulose may be within a side chain of the polymer. In this regard, the quaternized portion of the cellulose may have the following general structure:

[N⁺R¹⁰R¹¹ R¹²R¹³] [M⁻]

wherein

R¹⁰, R¹¹, R¹², and R¹³ independently of one another can be H, a C₁-C₆ alkyl, a C₁-C₆ alkenyl, a C₁-C₆ alkynyl wherein at least one of R¹⁰, R¹¹, R¹², and R¹³ is a direct bond or a linking group to the backbone of the cellulose polymer; and

M includes a counterion.

As indicated above, R¹⁰, R¹¹, R¹², and R¹³ independently of one another can be H, a C₁-C₆ alkyl, a C₁-C₆ alkenyl, a C₁-C₆ alkynyl wherein at least one of R¹⁰, R¹¹, R¹², and R¹³ is a direct bond or a linking group to the backbone of the cellulose polymer. It should be understood that any two of the aforementioned groups may be combined to form the aforementioned alkyl, alkenyl, or alkynyl groups. For instance, R₁₀ and R₁₁ may be combined and connected to form a C₁-C₆ alkyl or a C₁-C₆ alkenyl. In addition, it should be understood that the aforementioned groups may also be optionally substituted (e.g., hydroxyl, amino, carboxyl, etc.) as generally known in the art.

In one embodiment, at least two of R¹⁰, R¹¹, R¹², and R¹³ may be a C₁-C₆ alkyl (e.g., methyl, ethyl, etc.). In one embodiment, at least one, such as at least two, of R¹⁰, R¹¹, R¹², and R¹³ may a C₁-C₆ alkenyl (e.g., ethenyl, propenyl, etc.). In one particular embodiment, at least two of R¹⁰, R¹¹, R¹², and R¹³ may be a C₁-C₆ alkyl (e.g., methyl, ethyl, etc.) and at least one of R¹⁰, R¹¹, R¹², and R¹³ may be a C₁-C₆ alkenyl (e.g., ethenyl, propenyl, etc.). In another particular embodiment, at least one, such as at least two, of R¹⁰, R¹¹, R¹², and R¹³ may a C₁-C₆ alkenyl (e.g., ethenyl, propenyl, etc.). In one particular embodiment, at least two of R¹⁰, R¹¹, R¹², and R¹³ may be a C₁-C₆ alkyl (e.g., methyl, ethyl, etc.) and at least two of R¹⁰, R¹¹, R¹², and R¹³ may be a C₁-C₆ alkenyl (e.g., ethenyl, propenyl, etc.).

As indicated above, at least one of R¹⁰, R¹¹, R¹², and R¹³ is a direct bond or a linking group to the backbone of the cellulose polymer. In this regard, the group may be linked or bonded to an atom within the backbone of the cellulose polymer. In one embodiment, at least one of R¹⁰, R¹¹, R¹², and R¹³ is a direct bond. In another embodiment, at least one of R¹⁰, R¹¹, R¹², and R¹³ is a linking group linking the nitrogen atom to the cellulose polymer. The linking group is not necessarily limited by the present invention. In one embodiment, the linking group may include an ethoxylated group (—CH₂—CH₂—O—), a propoxylated group (—CH₂—CH₂—CH₂—O— or —CH₂—CH₂(CH₃)—O—), an alkylene (e.g., methylene, ethylene, propylene, etc.) or a substituted alkylene, a heteroatom (i.e., an —O—, an —N—, an —S—, etc.), or a combination thereof. For instance, the substituted alkylene may be an alkylene wherein a hydrogen is substituted for a functional group, such as an amine, a hydroxyl, a carboxyl, etc. In one particular embodiment, the functional group is a hydroxyl group. While certain linking groups are mentioned above, it should be understood that other linking groups as generally known in the art may also be utilized.

In one embodiment, the linking group may include at least an ethoxylated group. In another embodiment, the linking group may include at least an alkylene, such as a substituted alkylene and in particular a substituted propylene. In a further embodiment, the linking group may include a combination of an ethoxylated group and an alkylene, such as a substituted alkylene and in particular a substituted propylene. In this regard, the alkylene may be a propylene, such as a substituted propylene wherein the substitution is a hydroxyl group to provide —CH₂—CHOH—CH₂—. In a further embodiment, the linking group may include a combination of an ethoxylated group and —CH₂—CHOH—CH₂—.

As indicated above, the compound above includes a counterion (M). Suitable counterions for the cationic species may include, for example, halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. In one embodiment, the counterion includes a halide. The halide may be a fluoride, a chloride, a bromide, an iodide, or a mixture thereof. In one embodiment, the halide may be a fluoride. In another embodiment, the halide may be a bromide. In a further embodiment, the halide may be a chloride.

While not necessarily limited, the polycationic polymer may have a weight average molecular weight of 25,000 g/mol or more, such as 50,000 g/mol or more, such as 100,000 g/mol or more, such as 150,000 g/mol or more, such as 200,000 g/mol or more. The polycationic polymer may have a molecular weight of 1,000,000 g/mol or less, such as 750,000 g/mol or less, such as 500,000 g/mol or less, such as 400,000 g/mol or less, such as 350,000 g/mol or less. In this regard, the polycationic polymer can be a film-forming polymer. That is, the polycationic polymer may be formed into a polymeric solution that can be applied to a substrate wherein the solvent evaporates resulting in the formation of a film. Such processes and polymeric solutions are generally different than those films formed using extrusion and blow molding processes.

The polycationic polymer is present in the coating in an amount of 25 wt. % or more, such as 30 wt. % or more, such as 40 wt. % or more, such as 50 wt. % or more, such as 75 wt. % or more, such as 85 wt. % or more, such as 90 wt. % or more, such as 95 wt. % or more, such as 97 wt. % or more, such as 98 wt. % or more based on the weight of the coating. The polycationic polymer is present in the coating in an amount of less than 100 wt. %, such as 99 wt. % or less, such as 95 wt. % or less, such as 90 wt. % or less, such as 80 wt. % or less, such as 70 wt. % or less, such as 60 wt. % or less, such as 50 wt. % or less based on the weight of the coating.

The polycationic polymer is present in the coating in an amount of 50 wt. % or more, such as 60 wt. % or more, such as 70 wt. % or more, such as 80 wt. % or more, such as 90 wt. % or more, such as 95 wt. % or more, such as 97 wt. % or more, such as 98 wt. % or more based on the total polymer content of the coating. The polycationic polymer is present in the coating in an amount of less than 100 wt. %, such as 90 wt. % or less, such as 80 wt. % or less, such as 70 wt. % or less based on the total polymer content of the coating.

ii. Polyoxazoline

As indicated herein, the coating may include a further polymer. For instance, the coating may also include at least one polyoxazoline. The polyoxazoline may have a repeating unit represented by the following formula:

—[N(R¹)—(CHR²)ₘ]— (I)

wherein:

R¹ is R³—(CHR⁴)n—(CONH)ₚ—R⁵;

R² is selected from H and optionally substituted C₁₋₅ alkyl;

R³ is CO, C(O)O, C(O)NH or C(S)NH;

R⁴ is selected from H and optionally substituted C₁₋₅ alkyl;

R⁵ is H; an C₁₋₅ alkyl; aryl; or a moiety comprising a functional group selected from an amine, an oxyamine, a thiol, a phosphine, an alkynyl, an alkenyl, an aryl, an aldehyde, a carbonyl, an acetal, an ester, a carboxyl, a carbonate, a chloroformate, a hydroxyl, an ether an azide, a vinyl sulfone, a maleimide, an isocyanate, isothiocyanate, an epoxide, orthopyridyl disulfide, sulfonate, halo acetamide, halo acetic acid, hydrazine, and anhydride;

m is 2 or 3;

n is 0-5; and

p is 0 or 1.

As indicated above, R² is selected from H and optionally substituted C₁₋₅ alkyl. In one embodiment, R² is an optionally substituted C₁₋₅ alkyl. In one particular embodiment, R² is H.

As indicated above, R³ is CO, C(O)O, C(O)NH or C(S)NH. In one embodiment, R³ is CO, C(O)O, or C(O)NH. In another embodiment, R3 is CO or C(O)O. In one particular embodiment, R³ is CO.

As indicated above, R⁴ is selected from H and optionally substituted C₁₋₅ alkyl. In one embodiment, R⁴ is an optionally substituted C₁₋₅ alkyl. In one particular embodiment, R⁴ is H.

As indicated above, R⁵ is H; an C₁₋₅ alkyl; aryl; or a moiety comprising a functional group selected from an amine, an oxyamine, a thiol, a phosphine, an alkynyl, an alkenyl, an aryl, an aldehyde, a ketone, an acetal, an ester, a carboxyl, a carbonate, a chloroformate, a hydroxyl, an ether an azide, a vinyl sulfone, a maleimide, an isocyanate, isothiocyanate, an epoxide, orthopyridyl disulfide, sulfonate, halo acetamide, halo acetic acid, hydrazine, and anhydride. In one embodiment, R⁵ is H. In one particular embodiment, R⁵ is a C₁₋₅ alkyl, such as a methyl or ethyl group, in particular an ethyl group.

As indicated above, m is 2 or 3. In one embodiment, m is 3. In one particular embodiment, m is 2.

As indicated above, n is 0-5. In one embodiment, n is 1-5. In one particular embodiment, n is 0.

As indicated above, p is 0 or 1. In one embodiment, p is 1. In one particular embodiment, p is 0.

While the aforementioned structure is provided, it should be understood that other polyoxazoline having other structures may also be employed according to the present invention. For instance, such polyoxazolines may have additional or alternative substituent groups, for example as a result of additional or alternative substituent groups present in the pre-polymerized oxazoline compound.

According to one embodiment, the polyoxazoline may be a poly(2-oxazoline). In particular, the polyoxazoline may be a poly(2-substituted-2-oxazoline). For instance, the substitution may be an alkyl group. For instance, the alkyl group may be a C₁-C₁₀ alkyl group, such as a C₂-C₁₀ alkyl group, such as a C₂-C₉ alkyl group, such as a C₂-C₅ alkyl group. For instance, the alkyl group may be a methyl group, an ethyl group, a propyl group, a butyl group, a pentyl group, a hexyl group, a heptyl group, an octyl group, a nonyl group, a decyl group, etc. In this regard, the polyoxazoline may be a poly(2-alkyl-2-oxazoline). For instance, the polyoxazoline may be poly(2-methyl-2-oxazoline), poly(2-ethyl-2-oxazoline), poly(2-propyl-2-oxazoline), poly(2-butyl-2-oxazoline), poly(2-pentyl-2-oxazoline), poly(2-methyl-2-oxazoline), poly(2-hexyl-2-oxazoline), poly(2-heptyl-2-oxazoline), poly(2-octyl-2-oxazoline), poly(2-nonyl-2-oxazoline), poly(2-decyl-2-oxazoline), etc. In one particular embodiment, the polyoxazoline may be poly(2-ethyl-2-oxazoline).

The polyoxazoline may also be one having a terminal functional group. For instance, the functional group may be a hydroxyl group (e.g., a hydroxyalkyl group, such as a hydroxyethyl group, or a hydroxyalkylamine group, such as a hydroxyethylamine group), a thiol group, an alkynyl group, an alkenyl group, an amine group, etc. The polyoxazoline may be poly(2-ethyl-2-oxazoline) α-methyl, ω-2-hydroxyethylamine terminated, poly(2-ethyl-2-oxazoline) α-benzyl, ω-thiol terminated, poly(2-ethyl-2-oxazoline) alkyne terminated and poly(2-ethyl-2-oxazoline) amine terminated, and the like. In this regard, with such functional groups, the polyoxazoline may be a poly(2-ethyl-2-oxazoline) with a terminal functional group.

Generally, the polyoxazoline includes those polymers typically formed from oxazolines. The polyoxazoline can be formed by a ring-opening polymerization of an oxazoline, such as a 2-oxazoline, as generally known in the art. The ring-opening polymerization can generally be conducted in the presence of a cationic polymerization catalyst at a reaction temperature of about 0° C. to about 200° C. The catalyst may include, but is not limited, to strong mineral acids, organic sulfonic acids and their esters, acidic salts such as ammonium sulfate, Lewis acids such as aluminum trichloride, stannous tetrachloride, boron trifluoride and organic diazoniumfluoroborates, dialkyl sulfates and other like catalysts.

In addition to the above, it should be understood that the polyoxazoline may also be a copolymer. For instance, in addition to the oxazoline monomer, a second monomer as known in the art may also be polymerized with such oxazoline monomer to form a polyoxazoline that is a copolymer. Such second monomer may be another oxazoline monomer or another type of monomer.

While not necessarily limited, the polyoxazoline may have a weight average molecular weight of 1,000 g/mol or more, such as 5,000 g/mol or more, such as 10,000 g/mol or more, such as 25,000 g/mol or more, such as 35,000 g/mol or more, such as 40,000 g/mol or more, such as 45,000 g/mol or more, such as 50,000 g/mol or more. The polyoxazoline may have a molecular weight of 1,000,000 g/mol or less, such as 750,000 g/mol or less, such as 500,000 g/mol or less, such as 250,000 g/mol or less, such as 200,000 g/mol or less, such as 150,000 g/mol or less, such as 100,000 g/mol or less, such as 80,000 g/mol or less, such as 70,000 g/mol or less, such as 60,000 g/mol or less, such as 55,000 g/mol or less. In this regard, the polyoxazoline can be a film-forming polymer. That is, the polyoxazoline may be formed into a polymeric solution that can be spread over a substrate wherein the solvent evaporates resulting in the formation of a film. Such processes and polymeric solutions are generally different than those films formed using extrusion and blow molding processes.

The polyoxazoline is present in the coating in an amount of 0.1 wt. % or more, such as 0.5 wt. % or more, such as 1 wt. % or more, such as 5 wt. % or more, such as 10 wt. % or more, such as 15 wt. % or more, such as 20 wt. % or more, such as 25 wt. % or more, such as 30 wt. % or more based on the weight of the coating. The polyoxazoline is present in the coating in an amount of 50 wt. % or less, such as 40 wt. % or less, such as 30 wt. % or less, such as 20 wt. % or less, such as 10 wt. % or less, such as 5 wt. % or less, such as 3 wt. % or less, such as 2 wt. % or less based on the weight of the coating.

The polyoxazoline is present in the coating in an amount of 0.1 wt. % or more, such as 0.5 wt. % or more, such as 1 wt. % or more, such as 5 wt. % or more, such as 10 wt. % or more, such as 15 wt. % or more, such as 20 wt. % or more, such as 25 wt. % or more, such as 30 wt. % or more based on the total polymer content of the coating. The polyoxazoline is present in the coating in an amount of 50 wt. % or less, such as 40 wt. % or less, such as 30 wt. % or less, such as 20 wt. % or less, such as 10 wt. % or less, such as 5 wt. % or less, such as 3 wt. % or less, such as 2 wt. % or less based on the total polymer content of the coating.

The weight ratio of the polycationic polymer to the polyoxazoline may be 2.5 or more, such as 3 or more, such as 4 or more, such as 5 or more, such as 6 or more, such as 10 or more, such as 25 or more, such as 50 or more, such as 75 or more, such as 80 or more. The weight ratio of the polycationic polymer to the polyoxazoline may be less than 100, such as 90 or less, such as 85 or less, such as 70 or less, such as 50 or less, such as 25 or less, such as 15 or less, such as 10 or less, such as 8 or less, such as 7 or less, such as 5 or less, such as 4 or less, such as 3 or less.

As indicated herein, the coating may include at least one polyoxazoline. However, it should be understood that another polymer in addition to or in lieu of the polyoxazoline may be employed in addition to the polyoxazoline polymer. For instance, as indicated herein, the coating includes a polycationic polymer containing a nitrogen atom or a phosphorus atom. The second polymer may include a functional group or substituent group that includes a highly electronegative atom. In this regard, an electrostatic interaction (i.e., an attraction) may exist between the nitrogen atom or the phosphorus atom and the highly electronegative atom of the functional or substituent group of the second polymer. For instance, the highly electronegative atom may be a nitrogen atom, an oxygen atom, or a fluorine atom. In one particular embodiment, the highly electronegative atom may be an oxygen atom. As a result, an electrostatic interaction may exist between the nitrogen atom or the phosphorus atom of the polycationic polymer and an oxygen atom of the functional or substituent group of the second polymer. In one particular embodiment, an electrostatic interaction may exist between the nitrogen atom of the polycationic polymer and an oxygen atom of the functional or substituent group of the second polymer. In such instance when the second polymer of the coating is defined as such, it may be present in the same concentrations as indicated above for the polyoxazoline polymer. In this regard, any reference to the polyoxazoline polymer herein may also apply to the second polymer as defined herein.

iii. Polyacrylamide

As indicated herein, the coating may include a further polymer. For instance, the coating may also include at least one polyacrylamide. In general, the term “polyacrylamide” is mainly intended to apply to polymers or copolymers containing acrylamide. For instance, the polyacrylamide may be a homopolymer. Alternatively, the polyacrylamide may have a copolymer content of up to 25% by weight, such as up to 15% by weight, such as up to 5% by weight. Without intending to be limited by theory, these polymers may be considered a polyelectrolyte with which water-soluble polymers having a positive electrical charge are obtained.

The polyacrylamide may have a molecular weight of 1,000 g/mol or more, such as 2,000 g/mol or more, such as 5,000 g/mol or more, such as 10,000 g/mol or more, such as 20,000 g/mol or more, such as 50,000 g/mol or more, such as 100,000 g/mol or more, such as 200,000 g/mol or more, such as 500,000 g/mol or more. The polyacrylamide may have a molecular weight of 2,000,000 g/mol or less, such as 1,500,000 g/mol or less, such as 1,000,000 g/mol or less, such as 750,000 g/mol or less, such as 600,000 g/mol or less, such as 500,000 g/mol or less, such as 400,000 g/mol or less.

The polyacrylamide is present in the coating in an amount of 0.1 wt. % or more, such as 0.5 wt. % or more, such as 1 wt. % or more, such as 5 wt. % or more, such as 10 wt. % or more, such as 15 wt. % or more, such as 20 wt. % or more, such as 25 wt. % or more, such as 30 wt. % or more based on the weight of the coating. The polyacrylamide is present in the coating in an amount of 50 wt. % or less, such as 40 wt. % or less, such as 30 wt. % or less, such as 20 wt. % or less, such as 10 wt. % or less, such as 5 wt. % or less, such as 3 wt. % or less, such as 2 wt. % or less based on the weight of the coating.

The polyacrylamide is present in the coating in an amount of 0.1 wt. % or more, such as 0.5 wt. % or more, such as 1 wt. % or more, such as 5 wt. % or more, such as 10 wt. % or more, such as 15 wt. % or more, such as 20 wt. % or more, such as 25 wt. % or more, such as 30 wt. % or more based on the total polymer content of the coating. The polyacrylamide is present in the coating in an amount of 50 wt. % or less, such as 40 wt. % or less, such as 30 wt. % or less, such as 20 wt. % or less, such as 10 wt. % or less, such as 5 wt. % or less, such as 3 wt. % or less, such as 2 wt. % or less based on the total polymer content of the coating.

C. Coating Solution

In general, the coating of the present invention can be formed using any method generally known in the art. For instance, a coating solution of the polymers may be formed and thereafter applied to a surface of the glass substrate. In particular, a first coating solution containing the polycationic polymer may be combined with a second coating solution, such as one containing another polymer such as a polyoxazoline. In this regard, two pre-coating solutions may be combined to form the final coating solution. In another embodiment, however, the polymers may be initially combined and dissolved within the same coating solution such that there is no need to combine two pre-coating solutions.

The method of application to the glass substrate is not necessarily limited. For instance, the coating solution may be applied to the glass substrate using any method generally known in the art. These methods include, but are not limited to, spraying, dipping, brushing, etc. Once applied to a surface of the glass substrate, the coating solution is allowed to dry thereby allowing the formation of a coating on the glass substrate. Such drying may be at room temperature or in a heated chamber.

In this regard, the coating solution may contain a solvent. The solvent is not necessarily limited and may generally be any solvent employed in the art. In one embodiment, the solvent includes water. The solvent may be present in the coating solution in an amount of 50 wt. % or more, such as 60 wt. % or more, such as 70 wt. % or more, such as 80 wt. % or more, such as 90 wt. % or more, such as 95 wt. % or more, such as 97 wt. % or more, such as 98 wt. % or more based on the weight of the coating solution. The solvent may be present in the coating solution in an amount of less than 100 wt. %, such as 99 wt. % or more based on the weight of the coating solution.

In one embodiment, the coating solution may also include an organic amine. Such organic amine may also be present in the final coating. Without intending to be limited by theory, the organic amine may be present as a chelator whereby any metal ions, such as sodium ions, may chelate with the organic amine. Such chelation may also minimize, or prevent, the formation of a metal hydroxide, such as sodium hydroxide, and minimize the corrosion of the glass substrate.

The organic amine may be a primary amine, a secondary amine, a tertiary amine, a quaternary amine, or a combination thereof. In one embodiment, the organic amine includes a primary amine. In another embodiment, the organic amine includes a secondary amine. In another embodiment, the organic amine includes a tertiary amine. In another embodiment, the organic amine includes a quaternary amine. Such organic amine may be a discrete compound rather than a polymer as mentioned above. For instance, such organic amine may have a molecular weight of 5,000 g/mol or less, such as 2,500 g/mol or less, such as 1,000 g/mol or less, such as 500 g/mol or less, such as 250 g/mol or less, such as 200 g/mol or less.

The organic amine may include one having a functional group. For instance, the functional group may be a hydroxyl group. In this regard, the organic amine may have hydroxyalkyl groups. The organic amine may have one hydroxyl group, two hydroxyl groups, three hydroxyl groups, or four hydroxyl groups. In one embodiment, the organic amine has one hydroxyl group. In another embodiment, the organic amine has two hydroxyl groups. In a further embodiment, the organic amine has three hydroxyl groups. In another embodiment, the organic amine has four hydroxyl groups. As indicated above, it should be understood that such hydroxyl groups may be the terminal groups of an alkyl group such that the combination of the alkyl groups and hydroxyl groups may be referred to as a hydroxyalkyl group.

The organic amine may include, but is not limited to, an ethanolamine. In one embodiment, the organic amine includes an ethanolamine. The ethanolamine may include monoethanolamine, diethanolamine, triethanolamine, or a mixture thereof. In one embodiment, the ethanolamine includes monoethanolamine. In another embodiment, the ethanolamine includes diethanolamine. In a further embodiment, the ethanolamine includes triethanolamine.

The organic amine may have a boiling temperature (at atmospheric pressure) of 50° C. or more, such as 100° C. or more, such as 125° C. or more, such as 150° C. or more, such as 200° C. or more, such as 250° C. or more, such as 300° C. or more, such as 350° C. or more. In this regard, the organic amine may be present within the coating even after drying.

The organic amine may be present in the coating solution in an amount of 5 wt. % or more, such as 10 wt. % or more, such as 25 wt. % or more, such as 35 wt. % or more, such as 40 wt. % or more, such as 50 wt. % or more based on the weight of the coating solution. The organic amine may be present in the coating solution in an amount of 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less based on the weight of the coating solution.

The organic amine may be present in the coating in an amount of 5 wt. % or more, such as 10 wt. % or more, such as 25 wt. % or more, such as 35 wt. % or more, such as 40 wt. % or more, such as 50 wt. % or more based on the weight of the coating. The organic amine may be present in the coating in an amount of 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less based on the weight of the coating.

In one embodiment, the coating solution may also contain a surfactant. For instance, the surfactant may be a non-ionic surfactant, a cationic surfactant, an anionic surfactant, or a mixture thereof. In one embodiment, the surfactant includes an anionic surfactant. In another embodiment, the surfactant may be a non-ionic surfactant. Without intending to be limited by theory, the present inventor has discovered that the surfactant may allow for a reduction in the surface tension of the coating solution and thus allow for the formation of a relatively uniform coating.

The surfactant is not necessarily limited and may be any surfactant generally known in the art. The surfactant may be a discrete compound as generally known in the art. In addition, the surfactant may be an oligomeric or polymerizable surfactant as generally known in the art.

As indicated above, in one embodiment, the coating solution may include an anionic surfactant. In general, anionic surfactants include those having one or more negatively charged functional groups. For instance, the anionic surfactant includes alkali metal or ammonium salts of alkyl, aryl or alkylaryl sulfonates, sulfates, phosphates. For instance, the anionic surfactant may include sodium lauryl sulfate, sodium octylphenol glycolether sulfate, sodium dodecylbenzene sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt.

In one particular embodiment, the anionic surfactant includes a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, and 2-acetamido hexadecane sulfonates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, a lauryl sulfate (e.g., triethanol lauryl sulfate), or a mixture thereof.

The anionic surfactant may include an amine. For instance, the anionic surfactant may include a tertiary amine. The tertiary amine may not necessarily be limited by the present invention.

As indicated above, in one embodiment, the coating solution may include a non-ionic surfactant. The non-ionic surfactant may be generally as known in the art. Generally, nonionic surfactants include, but are not limited to, amine oxides, fatty acid amides, ethoxylated fatty alcohols, block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics).

As indicated above, in one embodiment, the coating solution may include a cationic surfactant. Examples of the cationic surfactant may include water-soluble quaternary ammonium compounds, polyammonium salts, a polyoxyethylene alkylamine and the like.

The surfactant may be present in the coating solution in an amount of 0.001 wt. % or more, such as 0.01 wt. % or more, such as 0.025 wt. % or more, such as 0.05 wt. % or more, such as 0.1 wt. % or more, such as 0.15 wt. % or more, such as 0.25 wt. % or more, such as 0.5 wt. % or more, based on the weight of the coating solution. The surfactant may be present in the coating solution in an amount of 5 wt. % or less, such as 4 wt. % or less, such as 3 wt. % or less, such as 2 wt. % or less, such as 1 wt. % or less, such as 0.5 wt. % or less, such as 0.4 wt. % or less, such as 0.25 wt. % or less, such as 0.2 wt. % or less, such as 0.1 wt. % or less, such as 0.05 wt. % or less, based on the weight of the coating solution.

In one embodiment, the surfactant may also be present in the final coating. The surfactant may be present in the coating in an amount of 0.001 wt. % or more, such as 0.01 wt. % or more, such as 0.025 wt. % or more, such as 0.05 wt. % or more, such as 0.1 wt. % or more, such as 0.15 wt. % or more, such as 0.25 wt. % or more, such as 0.5 wt. % or more, based on the total weight of the coating. The surfactant may be present in the coating solution in an amount of 5 wt. % or less, such as 4 wt. % or less, such as 3 wt. % or less, such as 2 wt. % or less, such as 1 wt. % or less, such as 0.5 wt. % or less, such as 0.4 wt. % or less, such as 0.25 wt. % or less, such as 0.2 wt. % or less, such as 0.1 wt. % or less, such as 0.05 wt. % or less, based on the total weight of the coating.

According to another embodiment, the present invention may also be directed to a coating solution. For instance, the coating solution may include the polycationic polymer and if present, another polymer, such as a polyoxazoline as defined herein. In addition, the coating solution may also include the solvent as defined herein. Further, the coating solution may also include the organic amine as defined herein. Also, the coating solution may also include the surfactant as defined herein.

Once dried, the coating may have a thickness as desired. For instance, the thickness may be about 1 μm or more, such as about 2 μm or more, such as about 5 μm or more, such as about 10 μm or more, such as about 20 μm or more. The coating may have a thickness of about 50 μm or less, such as about 40 μm or less, such as about 30 μm or less, such as about 25 μm or less, such as about 20 μm or less. However, it should be understood that any thickness may be obtained and that the present invention may not necessarily be limited by the thickness.

As indicated herein, the coating can minimize or inhibit corrosion of the glass substrate, especially during storage conditions. Once the glass substrate is ready for use, for example ready for cutting, chemical modifications, etc., by a distribution or end user, the coating disclosed herein may be removed if so desired. Such removal techniques may be any as generally known in the art. For instance, the coating can be removed by washing the coating with a solvent, such as water.

While embodiments of the present disclosure have been generally discussed, the present disclosure may be further understood by the following, non-limiting examples.

### EXAMPLES

### Test Methods

Ellipsometry: Ellipsometry was employed to measure Delta, which is the phase differenced induced by reflection, and is equal to (Delta_{before}-Delta_{after}) wherein Delta_{before} is the phase difference before the reflection and Delta_{after} is the phase difference after the reflection. The samples may be conditioned in a chamber at 85° C. and 85% humidity for 24 hours. Once removed from the chamber, the coated glass substrate was washed with deionized water and dried at room temperature for 2-3 hours before any measurements. The measurements are averages of three measurements on each glass substrate and three glass substrates were evaluated for each sample. Corrosion % is obtained by the equation (Delta_{RG}-Delta_{CG})/Delta_{RG}*100 wherein Delta_{RG} is the Delta value of the raw glass before conditioning in a chamber at 85° C. and 85% humidity for 24 hours and Delta_{CG} is the Delta value of the coated glass after conditioning in a chamber at 85° C. and 85% humidity for 24 hours. For the Delta value of the coated glass after conditioning, the coating layer is removed by washing with a brush and using deionized water in order to allow for the Delta measurement of the surface of the glass.

Atomic Force Microscopy: The topography is investigated by an atomic force microscope (AFM, AP-0100, Parker Sci. Instrument). The non-contact method, preferred for soft surface in general is used. The size of the sample is about 2 cm by 2 cm and the scanning area is 5,000 microns by 5,000 microns. The scanning speed of 20 microns/second. The surface roughness is quantitatively characterized by measuring the arithmetic average surface roughness (Ra) and root mean square surface roughness (Rq). For the surface roughness measurements of the coated glass after conditioning, the coating layer is removed by washing with a brush and using deionized water in order to allow for the Delta measurement of the surface of the glass.

Secondary Ion Mass Spectrometry: The hydrogen concentration of the glass substrate was measured using secondary ion mass spectrometry.

### Example 1

Coating solutions were prepared according to the samples provided below. Initially, a first coating solution was prepared by adding 10 grams of a 20% poly(diallyldimethylammonium chloride) in 40 grams of deionized water and the solution was stirred at room temperature for 1 hour. A second coating solution was prepared by adding 0.5 grams of poly(2-ethyl-2-oxazoline) in 20 grams of deionized water and the solution was stirred at room temperature for 3-4 hours. Then, respective amounts of the first coating solution and second coating solution were combined to form the coating solution as defined by the samples below. When triethanolamine was utilized, it was added to the solution and the solution was mixed by shaking.

The coating solution was then spray coated onto the glass substrate and dried at room temperature for 0.5 hours. Once the coating was dried, the coatings and glass substrates were evaluated to determine the Delta values and corrosion %.

| | Sample 1 | | Sample 2 | | Sample 3 | | Sample 4 | |
|---|---|---|---|---|---|---|---|---|
| | grams | wt. % | grams | wt. % | grams | wt. % | grams | wt. % |
| poly (diallyl | 0.1 | 0.57 | 0.1 | 0.44 | 0.1 | 0.8 | 0.06 | 0.48 |
| dimethylammonium chloride) | | | | | | | | |
| poly(2-ethyl-2-oxazoline) | 0.0012 | 0.01 | 0.0012 | 0.01 | — | — | 0.0244 | 0.20 |
| triethanolamine | — | — | — | — | — | — | — | — |
| water | 17.4488 | 99.42 | 22.4488 | 99.55 | 12.4 | 99.2 | 12.4156 | 99.32 |

| Delta | — | | — | | 165.1 | | 163.9 | |
|---|---|---|---|---|---|---|---|---|
| Corrosion % | — | | — | | 6.9 | | 7.62 | |
| | Sample 5 | | Sample 6 | | Sample 7 | | Sample 8 | |
| | grams | wt. % | grams | wt. % | grams | wt. % | grams | wt. % |
| poly (diallyl | 0.08 | 0.63 | 0.08 | 0.63 | 0.08 | 0.63 | 0.08 | 0.63 |
| dimethylammonium chloride) | | | | | | | | |
| poly(2-ethyl-2-oxazoline) | 0.0122 | 0.10 | 0.0122 | 0.10 | 0.0122 | 0.10 | 0.0122 | 0.10 |
| triethanolamine | 0.099 | 0.79 | 0.099 | 0.79 | 0.099 | 0.79 | 0.099 | 0.79 |
| water | 12.4088 | 98.48 | 12.4088 | 98.48 | 12.4088 | 98.48 | 12.4088 | 98.48 |

| | | | | |
|---|---|---|---|---|
| Delta | 171.0 | 174.3 | 172.4 | 173.6 |
| Corrosion % | 3.8 | 2.2 | 3.1 | 2.8 |

| | |
|---|---|
| Average Delta | 172.6 |
| STD | 1.7 |
| Average Corrosion % | 3.0 |
| STD | 0.8 |

As shown in the tables above, Samples 5-8 demonstrated improved performance with a higher Delta and a lower corrosion percentage after conditioning in a chamber at 85° C. and 85% humidity for 24 hours.

In addition, surface roughness measurements were obtained of raw glass without chamber testing, raw glass after chamber testing at 85° C. and 85% humidity for 24 hours, and Sample 7 after chamber testing at 85° C. and 85% humidity for 24 hours. The results are presented in the table below.

| | | | | | Avg. Max | Avg. Max |
|---|---|---|---|---|---|---|
| | | | | | Height | Depth |
| | | Corro- | Rq | Ra | (Rpm) | (Rvm) |
| Sample | Delta | sion % | (nm) | (nm) | (nm) | (nm) |
| Raw glass w/o | 178.04 | 0 | 0.16 | 0.13 | 0.03 | −0.03 |
| chamber testing | | | | | | |
| Raw glass with | 141.8 | 20.35 | 2.84 | 2.26 | 2.69 | −2.45 |
| chamber testing | | | | | | |
| Sample 7 with | 172.49 | 3.13 | 0.22 | 0.18 | 0.08 | −0.07 |
| chamber testing | | | | | | |

As shown in the table above, the roughness of the glass substrate with the coating layer and conditioned in a chamber is similar to the initial raw glass substrate that was not conditioned in a chamber and did not include a coating. Furthermore, a relationship can be observed in that as Delta increases, the average surface roughness (Ra) and the root mean square surface roughness (Rq) decreased.

### Example 2

Coating solutions were prepared according to the samples provided below. Initially, a first coating solution was prepared by adding 10 grams of a 20% poly(diallyldimethylammonium chloride) in 40 grams of deionized water and the solution was stirred at room temperature for 1 hour. A second coating solution was prepared by adding 0.5 grams of poly(2-ethyl-2-oxazoline) in 20 grams of deionized water and the solution was stirred at room temperature for 3-4 hours. Then, respective amounts of the first coating solution and second coating solution were combined to form the coating solution as defined by the samples below. The triethanolamine is added to the solution and the solution is mixed by shaking. Then, the surfactant is added to the solution in the desired amount and the solution is mixed.

The coating solution was then spray coated onto the glass substrate and dried at room temperature for 0.5 hours. Once the coating was dried, the coatings and glass substrates were evaluated to determine the Delta values and corrosion %.

| | Sample 9 | | Sample 10 | | Sample 11 | | Sample 12 | |
|---|---|---|---|---|---|---|---|---|
| | grams | wt. % | grams | wt. % | grams | wt. % | grams | wt. % |
| poly (diallyl | 0.0635 | 0.63 | 0.0635 | 0.62 | 0.0635 | 0.63 | 0.0635 | 0.62 |
| dimethylammonium chloride) | | | | | | | | |
| poly(2-ethyl-2-oxazoline) | 0.0097 | 0.10 | 0.0097 | 0.09 | 0.0097 | 0.10 | 0.0097 | 0.09 |
| triethanolamine | 0.0786 | 0.78 | 0.0786 | 0.76 | 0.0786 | 0.78 | 0.0786 | 0.76 |
| polyoxyethylene alkylphenyl | 0.005 | 0.05 | 0.015 | 0.15 | — | — | — | — |
| ether | | | | | | | | |
| polyoxyethylene alkylether | — | — | — | — | 0.005 | 0.05 | 0.015 | 0.15 |
| sulfuric ester, sodium | | | | | | | | |
| water | 9.943 | 98.45 | 10.133 | 98.38 | 9.943 | 98.45 | 10.133 | 98.38 |

| | | | | |
|---|---|---|---|---|
| Delta | 174.9 | 177.5 | 175.4 | 171.4 |
| Corrosion % | 1.9 | 0.5 | 1.7 | 3.9 |

The raw uncoated glass after conditioning in a chamber at 85° C. and 85% humidity for 24 hours exhibited a Delta of 153.4 and a corrosion % of 14.0. Meanwhile, as shown in the table above, Samples 9-12 demonstrated improved performance with a higher Delta and a lower corrosion percentage after conditioning in a chamber at 85° C. and 85% humidity for 24 hours.

### Example 3

Coating solutions were prepared according to the details provided below. Initially, a first solution was prepared by adding 2 grams of a 2% poly(acrylamide-co-diallyl-dimethylammonium chloride) solution in deionized water, 0.5 grams of a 2.4% poly(2-ethyl-2-oxazoline) solution in deionized water, 0.1 grams of triethanolamine, and 10 grams of deionized water were mixed to provide a first solution. A second solution was prepared including 95 grams of deionized water and 5 grams of Hitenol RN-10 (polyoxyethylene alkylphenyl ether). Next, 10 grams of the first solution and 0.1 grams of the second solution were combined to provide a third solution. Finally, 4 grams of the third solution were combined with 16 grams of deionized water to provide to final coating solution.

The coating solution was then spray coated onto the glass substrate and dried at room temperature for 0.5 hours. Once the coating was dried, the coatings and glass substrates were evaluated to determine the Delta values and corrosion %.

In addition, surface roughness measurements were obtained of raw glass without chamber testing, raw glass after chamber testing at 85° C. and 85% humidity for 24 hours, and Sample 13 after chamber testing at 85° C. and 85% humidity for 24 hours. The results are presented in the table below.

| | | | | | Avg. Max | Avg. Max |
|---|---|---|---|---|---|---|
| | | | | | Height | Depth |
| | | Corro- | Rq | Ra | (Rpm) | (Rvm) |
| Sample | Delta | sion % | (nm) | (nm) | (nm) | (nm) |
| Raw glass w/o | — | 0 | 0.26 | 0.16 | 0.08 | −0.07 |
| chamber testing | | | | | | |
| Raw glass with | 147.93 | 16.88 | 4.72 | 3.85 | 2.51 | −1.45 |
| chamber testing | | | | | | |
| Sample 13 with | 173.82 | 1.06 | 0.55 | 0.41 | 0.22 | −0.12 |
| chamber testing | | | | | | |

As shown in the table above, the roughness of the glass substrate with the coating layer and conditioned in a chamber is similar to the initial raw glass substrate that was not conditioned in a chamber and did not include a coating. Furthermore, a relationship can be observed in that as Delta increases, the average surface roughness (Ra) and the root mean square surface roughness (Rq) decreased.

### Example 4

Coating solutions were prepared according to the details provided below. Initially, a first solution was prepared by adding 4 grams of a 1.96% quaternized hydroxyethyl cellulose ethoxylate solution in deionized water, 1 gram of a 2.4% poly(2-ethyl-2-oxazoline) solution in deionized water, 0.2 grams of triethanolamine, and 40 grams of deionized water were mixed to provide a first solution. A second solution was prepared including 95 grams of deionized water and 5 grams of Hitenol RN-10 (polyoxyethylene alkylphenyl ether). Next, 10 grams of the first solution and 0.1 grams of the second solution were combined to provide a third solution. Finally, 4 grams of the third solution were combined with 16 grams of deionized water to provide to final coating solution.

The coating solution was then spray coated onto the glass substrate and dried at room temperature for 0.5 hours. Once the coating was dried, the coatings and glass substrates were evaluated to determine the Delta values and corrosion %.

In addition, surface roughness measurements were obtained of raw glass without chamber testing, raw glass after chamber testing at 85° C. and 85% humidity for 24 hours, and Sample 14 after chamber testing at 85° C. and 85% humidity for 24 hours. The results are presented in the table below.

| | | | | | Avg. Max | Avg. Max |
|---|---|---|---|---|---|---|
| | | | | | Height | Depth |
| | | Corro- | Rq | Ra | (Rpm) | (Rvm) |
| Sample | Delta | sion % | (nm) | (nm) | (nm) | (nm) |
| Raw glass w/o | — | 0 | 0.261 | 0.161 | 0.0773 | −0.0672 |
| chamber testing | | | | | | |
| Raw glass with | 147.93 | 16.88 | 4.72 | 3.85 | 2.51 | −1.45 |
| chamber testing | | | | | | |
| Sample 14 with | 170.0 | 4.5 | 1.95 | 1.49 | 2.27 | −0.61 |
| chamber testing | | | | | | |

As shown in the table above, the roughness of the glass substrate with the coating layer and conditioned in a chamber is less than that of the raw glass after chamber testing. Furthermore, a relationship can be observed in that as Delta increases, the average surface roughness (Ra) and the root mean square surface roughness (Rq) decreased.

### Example 5

Coating solutions were prepared according to the details provided below. Initially, a first solution was prepared by adding 10 grams of a 4% poly(diallyl dimethlammonium chloride) solution in deionized water, 2.5 grams of a 2.4% poly(2-ethyl-2-oxazoline) solution in deionized water, 0.5 grams of an ˜50% triethanolamine lauryl sulfate solution in deionized water, and 50 grams of deionized water were mixed to provide a first solution. A second solution was prepared including 95 grams of deionized water and 5 grams of Hitenol RN-10 (polyoxyethylene alkylphenyl ether). Finally, the solution was diluted based on the amounts below.

| | Sample 15 | Sample 16 | Sample 17 |
|---|---|---|---|
| First solution (g) | 22 | 10 | 4 |
| Deionized water (g) | 5.5 | 10 | 16 |

The coating solutions were then spray coated onto the glass substrate and dried at room temperature for 0.5 hours. Once the coating was dried, the coatings and glass substrates were evaluated to determine the Delta values and corrosion %.

In addition, surface roughness measurements were obtained of raw glass without chamber testing, raw glass after chamber testing at 85° C. and 85% humidity for 24 hours, and Sample 16 after chamber testing at 85° C. and 85% humidity for 24 hours. The results are presented in the table below.

| | | | | | Avg. Max | Avg. Max |
|---|---|---|---|---|---|---|
| | | | | | Height | Depth |
| | | Corro- | Rq | Ra | (Rpm) | (Rvm) |
| Sample | Delta | sion % | (nm) | (nm) | (nm) | (nm) |
| Raw glass w/o | — | 0 | 0.261 | 0.161 | 0.0773 | −0.0672 |
| chamber testing | | | | | | |
| Raw glass with | 147.93 | 16.88 | 4.72 | 3.85 | 2.51 | −1.45 |
| chamber testing | | | | | | |
| Sample 16 with | 170 | 4.5 | 2.31 | 1.87 | 3.16 | −0.9 |
| chamber testing | | | | | | |

As shown in the table above, the roughness of the glass substrate with the coating layer and conditioned in a chamber is similar to the initial raw glass substrate that was not conditioned in a chamber and did not include a coating. Furthermore, a relationship can be observed in that as Delta increases, the average surface roughness (Ra) and the root mean square surface roughness (Rq) decreased.

### Example 6

Coating solutions were prepared according to the details provided below. Initially, a first solution was prepared by adding 4 grams of a 1.96% quaternized hydroxyethyl cellulose ethoxylate solution in deionized water, 1 gram of a 2.4% poly(2-ethyl-2-oxazoline) solution in deionized water, 0.2 grams of triethanolamine, and 40 grams of deionized water were mixed to provide a first solution. A second solution was prepared including 95 grams of deionized water and 5 grams of Hitenol RN-10 (polyoxyethylene alkylphenyl ether). Next, 20 grams of the first solution and 0.2 grams of the second solution were combined to provide a third solution. Finally, the solution was diluted based on the amounts below.

| | Sample 18 | Sample 19 | Sample 20 |
|---|---|---|---|
| First solution (g) | 20 | 8 | 32 |
| Deionized water (g) | 20 | 32 | 8 |

The coating solutions were then spray coated onto the glass substrate and dried at room temperature for 0.5 hours. Once the coating was dried, the coatings and glass substrates were evaluated to determine the Delta values and corrosion %.

The coating solution was then spray coated onto the glass substrate and dried at room temperature for 0.5 hours. Once the coating was dried, the coatings and glass substrates were evaluated to determine the Delta values and corrosion %.

In addition, surface roughness measurements were obtained of raw glass without chamber testing, raw glass after chamber testing at 85° C. and 85% humidity for 24 hours, and the samples after chamber testing at 85° C. and 85% humidity for 24 hours. The results are presented in the table below.

| Sample | Delta | Corrosion % |
|---|---|---|
| Raw glass w/o chamber testing | 177.7 | 0 |
| Raw glass with chamber testing | 114.9 | 35.3 |
| Sample 18 with chamber testing | 169.8 | 5.3 |
| Sample 19 with chamber testing | 168.3 | 2.1 |
| Sample 20 with chamber testing | 175.5 | 1.3 |

As shown in the table above, the Delta values and corrosion % are greater than the raw glass after chamber testing and comparable to the raw glass before chamber testing.

Example 7

Coating solutions were prepared according to the details provided below. Initially, a first solution was prepared by adding 3 grams of an 11.1% poly(diallyl dimethlammonium chloride) solution in deionized water, 1 gram of a 2.4% poly(2-ethyl-2-oxazoline) solution in deionized water, 1 gram of 13% polyacrylamide solution in deionized water, 0.2 grams of triethanolamine, and 20 grams of deionized water were mixed to provide a first solution. A second solution was prepared including 95 grams of deionized water and 5 grams of Hitenol RN-10 (polyoxyethylene alkylphenyl ether). A second solution was prepared including 95 grams of deionized water and 5 grams of Hitenol RN-10 (polyoxyethylene alkylphenyl ether). Next, 20 grams of the first solution and 0.2 grams of the second solution were combined to provide a third solution. Finally, 10 grams of the third solution were combined with 10 grams of deionized water to provide to first final coating solution (Sample 21).

Then, a fourth solution was prepared by adding 4 grams of a 1.96% quaternized hydroxyethyl cellulose ethoxylate solution in deionized water, 1 gram of a 2.4% poly(2-ethyl-2-oxazoline) solution in deionized water, 0.2 grams of triethanolamine, and 40 grams of deionized water were mixed to provide a fourth solution. A fifth solution was prepared including 95 grams of deionized water and 5 grams of Hitenol RN-10 (polyoxyethylene alkylphenyl ether). Next, 20 grams of the fourth solution and 0.2 grams of the fifth solution were combined to provide a sixth solution. Then, 20 grams of the sixth solution were combined with 20 grams of deionized water to provide to seventh solution. Finally, 9 grams of the seventh solution were combined with 1 gram of 13% polyacrylamide solution in deionized water to provide a second final coating solution (Sample 22).

The coating solutions were then spray coated onto the glass substrate and dried at room temperature for 0.5 hours. Once the coating was dried, the coatings and glass substrates were evaluated to determine the Delta values and corrosion %.

In addition, surface roughness measurements were obtained of raw glass without chamber testing, raw glass after chamber testing at 85° C. and 85% humidity for 24 hours, and Sample 16 after chamber testing at 85° C. and 85% humidity for 24 hours. The results are presented in the table below.

| Sample | Delta | Corrosion % |
|---|---|---|
| Raw glass w/o chamber testing | 177.7 | 0 |
| Raw glass with chamber testing | 114.9 | 35.3 |
| Sample 21 with chamber testing | 177.4 | 0.3 |
| Sample 22 with chamber testing | 176.9 | 0.4 |

As shown in the table above, the Delta values and corrosion % are greater than the raw glass after chamber testing and comparable to the raw glass before chamber testing.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A coated glass substrate comprising
a glass substrate; and
a coating on a surface of the glass substrate wherein the coating includes a polycationic polymer; and
wherein the coated glass substrate has (1) a Delta of greater than 165, (2) an average corrosion percent of less than 7%, or (3) both.

2. The coated glass substrate according to claim 1, wherein the coated glass substrate has a Delta of 170 or more.

3. The coated glass substrate according to claim 1, wherein the coated glass substrate has a Delta of 174 or more.

4. The coated glass substrate according to claim 1, wherein the coated glass substrate has an average corrosion percent of less than 4%.

5. The coated glass substrate according to claim 1, wherein the coated glass substrate has a Delta of 170 or more and an average corrosion percent of less than 4%.

6. The coated glass substrate according to claim 1, wherein the polycationic polymer is present in an amount of from 25 wt. % to less than 100 wt. % based on the weight of the coating.

7. The coated glass substrate according to claim 1, wherein the polycationic polymer is formed from a compound having the following general structure:
[X⁺R⁶R⁷R⁸R⁹] [Y⁻]
wherein
X is N or P;
R⁶, R⁷, R⁸, and R⁹ independently of one another can be H, a C₁-C₆ alkyl, a C₁-C₆ alkenyl, a C₁-C₆ alkynyl wherein at least one of R⁶, R⁷, R⁸, and R⁹ includes at least one unsaturated carbon bond; and
Y includes a counterion.

8. The coated glass substrate according to claim 1, wherein the polycationic polymer includes a quaternary ammonium polymer.

9. The coated glass substrate according to claim 1, wherein the polycationic polymer includes a polyquaternium polymer.

10. The coated glass substrate according to claim 1, wherein the polycationic polymer includes poly(diallyl dimethylammonium) chloride.

11. The coated glass substrate according to claim 1, wherein the polycationic polymer includes a quaternized cellulose.

12. The coated glass substrate according to claim 11, wherein the quaternized cellulose includes a quaternized cellulose derivative.

13. The coated glass substrate according to claim 1, wherein the coating further includes a polyoxazoline.

14. The coated glass substrate according to claim 13, wherein the polyoxazoline includes a poly(2-alkyl-2-oxazoline) and wherein the alkyl comprises a C₁-C₁₀ alkyl group.

15. The coated glass substrate according to claim 1, wherein the coating further includes a polyacrylamide.

16. The coated glass substrate according to claim 1, wherein the coating further includes an organic amine.

17. The coated glass substrate according to claim 16, wherein the organic amine includes an ethanolamine.

18. The coated glass substrate according to claim 1, wherein the coating further includes a surfactant.

19. The coated glass substrate according to claim 18, wherein the surfactant includes an anionic surfactant.

20. The coated glass substrate according to claim 19, wherein the anionic surfactant includes a polyoxyethylene alkylether sulfuric ester, a polyoxyethylene alkylphenyl ether sulfuric ester salt, or a mixture thereof.
